(19) United States
(12) Patent Application Publication
(10) Pub. No.: US 2008/0244260 A1
(43) Pub. Date: Oct. 2, 2008

(54) SYSTEM AND METHOD FOR MANAGING INTEROPERABILITY OF INTERNET TELEPHONY NETWORKS AND LEGACY TELEPHONY NETWORKS

(76) Inventors: Lowell Phillip Feldman, Austin, TX (US); Soren Williams Telfer, Ann Arbor, MI (US)

Correspondence Address: PILLSBURY WINTHROP SHAW PITTMAN, LLP, P.O. BOX 10500, MCLEAN, VA, 22102, US

(21) Appl. No.: 12/048,793

(22) Filed: Mar. 14, 2008

Related U.S. Application Data
(60) Provisional application No. 60/908,485, filed on Mar. 28, 2007.
(60) Provisional application No. 60/908,493, filed on Mar. 28, 2007.
(60) Provisional application No. 60/908,500, filed on Mar. 28, 2007.
(60) Provisional application No. 60/908,505, filed on Mar. 28, 2007.

(51) Int. Cl. H04L 9/28; G06F 15/16

(52) U.S. Cl. 713/153; 709/218

(57) ABSTRACT

A system and method for providing interoperability between Internet telephony networks and legacy telephony networks includes conveying an address of an Internet telephony endpoint in a legacy telephony protocol. A globally unique Uniform Resource Identifier, referred to as a Universal Global Title, may be assigned as the address of the Internet telephony endpoint. The URI-based address of the Internet telephony endpoint can be conveyed to a legacy telephony network as an Internet Address Parameter, implemented as an extension to the ANSI ISDN User Part legacy telephony protocol. As such, a Universal Teletraffic EXchange may be provided where Internet telephony networks and legacy telephony networks can exchange addressing and signaling information while interoperating at a peer-to-peer level.

### CROSS-REFERENCE TO RELATED APPLICATIONS

This application claims the benefit of U.S. Provisional Patent Application Ser. No. 60/908,485, entitled “Method of Providing Callback Capability from Switched Network Telephony Terminals to Packet Network Telephony Terminals,” U.S. Provisional Patent Application Ser. No. 60/908,493, entitled “Internet Address Parameter,” U.S. Provisional Patent Application Ser. No. 60/908,500, entitled “Universal Global Title,” and U.S. Provisional Patent Application Ser. No. 60/908,505, entitled “Method of Interconnecting Public Switched Telephone Network with IP Telephony Network Using Universal Global Title,” each of which were filed on Mar. 28, 2007, and the disclosures of which are hereby incorporated by reference in their entirety.

This application is related to the following co-pending applications, which are hereby incorporated by reference in their entirety: “System and Method for Managing Interoperability of Internet Telephony Networks and Legacy Telephone Networks,” Ser. No. 12/______, filed Mar. 14, 2008, Attorney Docket No. 091953-0368254; and “System and Method for Managing Interoperability of Internet Telephony Networks and Legacy Telephone Networks,” Ser. No. 12/______, filed Mar. 14, 2008, Attorney Docket No. 091953-0369030.

### FIELD OF THE INVENTION

The invention generally relates to a system and method for managing interoperability of Internet telephony networks and legacy telephony networks, and in particular, to representing Internet telephony addressing and other signaling information in a manner that operates with legacy telephony network carriers.

### BACKGROUND OF THE INVENTION

In the United States, the Public Switched Telephony Network (PSTN) encompasses various interconnected common carrier wire and radio switched networks, which employ the North American Numbering Plan (NANP) in connection with the provision of switched services. Although the PSTN generally operates using technology that has existed for decades, the PSTN continues to provide reliable service to hundreds of millions of wireline and mobile telephony subscribers. In particular, as technology has evolved over time, the telecommunications industry has typically initiated standardization efforts to integrate new technologies into the PSTN and ensure interoperability of telecommunications networks. For example, the Integrated Subscriber Digital Network (ISDN) is often viewed in the telecommunications industry as a core technology that adds new services to the PSTN, providing users with direct access to end-to-end circuit-switched digital services. As standardization efforts have tended to precede widespread deployments of these new technologies, the telecommunications industry has therefore operated under a consensus for interpretations and interoperability standards regarding various issues, including signaling, transport, addressing, and jurisdiction, among others.

For example, in recent years, rapid proliferation of communications systems based on Internet Protocol (IP) has led to various initiatives focused on standardizing IP-based telephony (e.g., Session Initiation Protocol, Media Gateway Control Protocol, H.323, etc.). Although the degree of involvement and commitment from the traditional telecommunications industry has varied from one standard to another, there has generally been at least an informal effort to standardize the interpretation and interoperability of these new IP-based standards with the PSTN. However, for various reasons, standardization efforts have lagged in areas relating to signaling and addressing, placing the telecommunications industry in an increasingly challenging and critically uncertain operating environment, particularly in relation to inter-provider charging schemes for traffic exchanged between legacy telephony networks and IP-based telephony networks.

More specifically, typical telephony applications involve one or more call sessions between telephony endpoints, where a telephony endpoint generally refers to a real or virtual network appearance capable of initiating and receiving messages and signals related to a telephony service. Thus, a key issue in many telephony applications involves the nature and interpretation of an identifier that a service provider uses to represent an originating telephony endpoint (i.e., the endpoint seeking to initiate a call session). In North America, for example, network operators typically represent PSTN telephony endpoints using a telephone number expressed as an E.164 address, where such addresses are typically assigned by a national number administration body referred to as the North America Numbering Plan Administration (NANPA). Further, to identify the telephony endpoint that initiated the call, traditional telephony applications commonly reference the E.164 address assigned to the endpoint as a Calling Party Number (CPN). Thus, as technology has developed and new types of telephony endpoints have emerged, efforts have been made to address the new types of endpoints in a manner that comports with the predominant NANP-based numbering scheme. For instance, in the Global System for Mobile communications (GSM), the prevailing standard for mobile phones worldwide, telephony endpoints receive E.212 addresses that follow a numbering scheme generally similar to that of the E.164 numbering scheme.

As such, the nature of interoperability for various telephony addressing schemes depends on effectively conveying PSTN numbering schemes to Internet telephony protocols. However, IP-based communications systems have evolved in a manner whereby protocol endpoints tend to be formally addressed in a very different way from endpoints in PSTN communication systems. For example, IP-based communications systems based on Simple Mail Transfer Protocol, HyperText Transfer Protocol, or other IP-based protocols typically employ a Uniform Resource Identifier (URI) to identify a network resource. The URI standard specifies that network resources should be identified according to a general syntax of “user@domain,” where each of “user” and “domain” may or may not have further internal structure. For instance, the domain of a typical URI includes, among other things, a top-level domain such as .com, .gov, .edu, .org, or .tv.

Following this practice, Internet telephony protocols typically at least have provisions for, if not exclusive use of, URI-based identifiers to represent telephony endpoints. However, URI-based schemes for identifying telephony endpoints create apparent issues relating to PSTN interoperability. In fact, various standards have been proposed to unambiguously encapsulate NANP-based addresses in IP-telephony derived URIs. Nonetheless, in spite of these efforts, a non-standardized practice has developed where the “user” portion of the URI represents the E.164 address, while the “domain” portion represents a network element that receives signaling information. However, this mapping suffers from various apparent problems, as it can only be employed when a URI and a NANP-based address are both available to be assigned to a particular user or domain. As such, existing practices have yet to successfully propose a scheme capable of interoperating with legacy telephony networks even in cases where a telephony endpoint does not have a NANP-based address that can be inserted into the URI.

Furthermore, various network operators have raised concerns regarding the validity of IP-derived telephony addresses. For example, IP-based telephony protocols generally provide significant flexibility in addressing endpoints, which has created a perception among some network operators that Calling Party Numbers derived from IP-based telephony protocols may be susceptible to misrepresentation. Moreover, the ubiquity of the NANP-based addressing scheme has created misunderstandings relating to the conceptual nature of telephony endpoints, even causing some in the telecommunications industry to wrongly believe that a NANP-based address is logically necessary for a telephony endpoint to exist. Finally, because signaling elements based on Signaling System 7 (SS7) cannot convey addresses other than a telephone number, and SS7 signaling elements are widely deployed throughout the PSTN, some have alleged URI-based schemes to be illegitimate or otherwise unsuitable for telephony.

As a result, existing techniques for providing addressing interoperability focus solely on the problem of representing legacy numbering in Internet telephony protocols. Therefore, where incumbent local exchange carriers (ILECs) have been unable to accurately bill network traffic because an origin thereof cannot be ascertained, carriers have tended to characterize the issue as “Phantom Traffic” that represents a manifestation of interoperability problems. However, as can be readily seen, the importance of this issue in the telecommunications industry belies the fact that Internet telephony protocols can easily encapsulate legacy protocols in a logical manner. Furthermore, players in the telecommunications industry have acknowledged that attempts to characterize the nature of the “Phantom Traffic” problem tend to be pure conjecture, as all that is currently known is that terminating traffic sometimes cannot be billed accurately. The fact that currently deployed SS7-based network elements cannot handle the URI syntax therefore presents apparent and significant technical problems.

Furthermore, as indicated above, the “Phantom Traffic Problem” relates to another important issue concerning the interoperability of telephony networks. In particular, telecommunications carriers typically link points of presence (POP) at access tandems within given geographical areas to provide centralized switching among carriers. As such, when carriers exchange traffic among networks, the exchanging carriers arrange for “settlements” or “inter-carrier compensation” to resolve costs associated with handling the traffic. However, because telecommunications providers and IP-based service providers peer in different ways, the industries have radically different inter-provider charging schemes for traffic exchanged between networks.

In the telecommunications industry, for example, the Federal Communications Commission (FCC) and the states tend to regulate settlements pursuant to federal and state legislation and administrative rules. These regulations generally require carriers to permit other carriers to interconnect on request (i.e., establish links that will support calls). For instance, dominant firms such as the larger incumbent telephone companies must allow other providers to interconnect at any technically feasible point within their network, typically within the Local Access and Transport Area (LATA) where a call originates or terminates. Moreover, reasonable terms must be provided, and facility charges must be cost-based. To that end, charges for traffic passed from one carrier to another are typically apportioned among the carriers based on a percent of originating use. For example, a carrier originating a call would be responsible for paying a terminating carrier for the costs associated with transporting and terminating the call. Additionally, if the call falls within the definition of a “telephone toll service,” regulations require a toll provider to compensate local exchange carriers (LECs) on whose network the call originates or terminates.

Telephony applications can therefore be subject to often complex and inefficient billing regimes. For example, a call traversing distinct carrier networks may be subject to either an “access charge” regime or a “reciprocal compensation” regime, where the “reciprocal compensation” regime generally has lower rates than the “access charge” regime. Differences between these regimes have led to a significant amount of litigation and regulatory attention. Furthermore, some participants argue that gaming occurs in these billing schemes, wherein carriers allegedly mask the true nature of a call to avoid being assessed high cost access charges and instead receive the benefits of lower cost reciprocal compensation. These issues result from various problems with the existing scheme, including the fact that the rules are replete with exceptions and conditions. Thus, uncertainty often arises as to whether a particular call falls within the higher cost “access charges” regime or the lower cost “reciprocal compensation” regime, especially when the call both originates and terminates on the PSTN.

Although the rules permit carriers to mutually agree to waive cost recovery through bill and keep arrangements, incumbent local exchange carriers tend to disfavor such arrangements because of the belief that lost profits may result. Under current default rules, the rate for inter-carrier compensation may depend on various factors, including the type of traffic at issue, the type of carriers involved, and the communication endpoints. These distinctions create opportunities for regulatory arbitrage, and further create incentives for inefficient investment and deployment decisions. For example, a long-distance call carried by an inter-exchange carrier (IXC) would be subject to a different regime than a local call carried by two local exchange carriers. In another example, different compensation rules govern calls handled by Commercial Mobile Radio Service (CMRS) providers, local exchange carriers, and Enhanced Service Providers.

The FCC has long recognized that the current rules make distinctions based on artificial and arbitrary classifications, which cannot be sustained in the modern telecommunications marketplace. Nonetheless, the FCC's efforts to move to a unified and rational compensation regime have yielded minimal progress, more litigation, and more intra-industry debate and contention. For example, local exchange carriers have been urging the FCC to impose specific rules governing signaling information that upstream carriers must provide to downstream carriers. Local exchange carriers have alleged that this signaling information would allow them to better identify or otherwise classify call sessions than upstream carriers who may be attempting to avoid responsibility for higher terminating charges. Thus, without commenting on the propriety of the local exchange carriers' demand for signaling information, or the utility thereof, existing techniques that IP-based telephony providers use to communicate signaling information are subject to various issues and concerns.

In contrast to the billing schemes employed in traditional telecommunications systems, IP-based service providers use a fundamentally different regime. In particular, larger providers generally have private agreements with one another for what may be referred to as “peering” and “transit,” where a settlement-free approach is typically employed among peers. The settlement-free approach rests on an assumption that traffic exchanged between peer networks introduces roughly equal burdens and values for each peering partner. As such, competition may be fostered because smaller providers can purchase connectivity and access to a larger provider's network, and can therefore communicate with any address available through the larger provider's network. Further, many smaller providers have collaborated to establish exchange points in an attempt to minimize charges from upstream providers. Thus, where charges are assessed between peers, for transit, or among smaller providers, the charges will usually be based on bandwidth usage rather than a complex scheme based on individual sessions, packets, or communications. Moreover, the type of application or the geography of endpoints in a given session usually has little or no impact on the charges for the session.

As such, the “access charge” or “inter-carrier compensation” schemes that prevail in traditional PSTN communications have no analogue in the billing schemes that IP-based service providers use. One reason for the lack of analogous billing schemes includes the ability to demand and receive transfer charges in excess of cost, as in the case of the “access charges” that incumbent local exchange carriers demand. However, because government regulations require facility charges to be cost-based, profitable schemes for handling transfer charges tend to be limited to cases when one player has significant market power. Correlatively, a general consensus has emerged whereby the costs associated with metering, rating, and billing are thought to far outweigh any benefits or incremental revenues that could be generated in a truly competitive market. However, to the extent that legacy signaling and addressing schemes remain necessary, it is to ensure proper routing and identification for communications, not to preserve above-cost transfer charges for legacy telephony carriers.

Therefore, a need exists for systems and methods that address one or more of these and/or other problems.

### SUMMARY OF THE INVENTION

According to various implementations of the invention, a system and method for providing interoperability between Internet telephony networks and legacy telephony networks includes conveying an address of an Internet telephony endpoint in a legacy telephony protocol. For example, a globally unique Uniform Resource Identifier (URI), referred to as a Universal Global Title (UGT), may be assigned as the address of the Internet telephony endpoint. The URI-based address of the Internet telephony endpoint can be conveyed to a legacy telephony network. For example, the UGT may be transmitted to a provider of an Internet telephony network using a Session Initiation Protocol or another protocol based on Internet Protocol (IP). Furthermore, the UGT may be transmitted to a provider of a legacy telephony network using an Internet Address Parameter (IAP), which may include an extension to the Signaling System 7 (SS7) ISDN User Part legacy telephony protocol. As such, a Universal Teletraffic EXchange (UTEX) may be provided where Internet telephony networks and legacy telephony networks can exchange addressing and signaling information while interoperating at a peer-to-peer level.

In various implementations of the invention, a system may provide a secure out of band signaling service to control data transfer among Internet Protocol (IP) telephony networks and legacy telephony networks. The system may include at least one point of presence communicatively coupled to a plurality of telephony networks. At least one of the plurality of telephony networks may communicate with the point of presence using an IP-based telephony protocol, and at least one of the plurality of telephony networks may communicate with the point of presence using an extensible legacy telephony protocol. The point of presence may receive a message from an originating telephony endpoint communicatively coupled to the at least one IP-based telephony network. The message may include a Uniform Resource Identifier (URI) uniquely identifying the originating telephony endpoint in a database associated with the point of presence. A terminating telephony endpoint may be identified from the received message, where the terminating telephony endpoint may be communicatively coupled to the at least one legacy telephony network. The point of presence may encode the URI identifying the originating telephony endpoint in accordance with an extension to the extensible legacy telephony protocol. The encoded URI may be communicated to the at least one legacy telephony network to establish a call session between the originating telephony endpoint and the terminating telephony endpoint.

Moreover, in various implementations of the invention, the UTEX may include various geographically distributed settlement-free exchange points where telephony service providers can exchange interoperable and standardized addressing and signaling information. The UTEX may therefore facilitate generally settlement-free transactions among service providers that register as members of the UTEX and may further ensure that signaling information will be preserved for delivery to a non-member local exchange carrier (e.g., in instances where a call session has an endpoint on the PSTN). Accordingly, the UTEX may address the aforementioned “Phantom Problem” by using addressing and signaling mechanisms that legacy telephony networks use to originate and terminate communications.

According to various implementations of the invention, a secure out of band signaling service may be provided to control use of wideband communications networks. For example, a signaling origination message may be received from an originating telephony endpoint, where the signaling origination message includes an identifier that uniquely represents the originating telephony endpoint in an out of band signaling network. The out of band signaling service further identifies a terminating telephony endpoint from signaling origination message. The out of band signaling service may then establish a call session between the originating telephony endpoint and the terminating telephony endpoint, with the call session defining a use of a wideband communications network.

Further, in various implementations of the invention, the out of band signaling service may provide identity control over the use of the wideband communications network based on the identifiers of the originating and terminating endpoints. In particular, the use of the wideband network may be controlled by authenticating, measuring, allocating, or otherwise identifying the use according to at least one of users, groups of users, devices, applications, or other identification criteria. As a result, traffic related to the call session can bypass various restrictions that a service provider may have placed on traffic traversing the wideband communications network. For example, the out of band signaling network may handle intelligence and/or other signaling for a bearer load, such that the bearer load need only provide data transport services to route and transmit data between the originating and terminating telephony points.

According to various implementations of the invention, peer-to-peer communications may be established through secure out of band signaling. A message may be received at a signaling device, where the message may include a request for content from a destination. The message may identify, among other things, an Internet address for the destination, a local area network address for a user terminal that initiated the request, a requested protocol such as a peer-to-peer protocol or a file transfer protocol, or other information. A query may be communicated to a signaling network to establish communications between the user terminal and the destination. For example, the signaling device may receive a response to the query that enumerates one or more nodes. Further, the enumerated nodes may be operable to proxy the message to the Internet destination on behalf of the user terminal by communicating with the destination using the requested protocol.

One or more Network Address Translation flows may be established at an Internet router for the proxied message. The Network Address Translation flows may allow the incoming data to securely tunnel a firewall at the Internet router. For example, the Network Address Translation flows may instruct the Internet router to accept incoming data from the one or more enumerated nodes on a randomized port, and to forward the incoming data to a local area network address for the signaling device. The enumerated nodes may provide the requested content to the Internet router through at least one Internet service provider network. The Internet router may to forward the requested content to the signaling device using the established Network Address Translation flows. As such, the requested content may be received at the signaling device, which may provide the content to the user terminal in accordance with the requested protocol, thus bypassing restrictions that an Internet service provider may have placed on traffic traversing the Internet service provider network.

Other objects and advantages of the invention will be apparent to those skilled in the art based on the following drawings and detailed description.

### BRIEF DESCRIPTION OF THE DRAWINGS

FIG. 1 illustrates, according to various implementations of the invention, a block diagram of an exemplary telecommunications network region in which a Universal Teletraffic EXchange manages interoperability of various telephony service provider networks.

FIGS. 2a-b illustrate, according to various implementations of the invention, a flow diagram of an exemplary method for establishing a call session between various telephony service provider networks in a Universal Teletraffic EXchange.

FIG. 3 illustrates, according to various implementations of the invention, a flow diagram of an exemplary method for routing signaling information in a Universal Teletraffic EXchange.

FIG. 4 illustrates, according to various implementations of the invention, a block diagram of an exemplary system for providing a secure out of band signaling network that can provide identity control for wideband public and private network usage.

FIG. 5 illustrates, according to various implementations of the invention, a flow diagram of an exemplary method for providing identity control in connection with a secure out of band signaling system.

### DETAILED DESCRIPTION

According to various implementations of the invention, a system and method as described in further detail herein may provide interoperability between an Internet telephony network and a legacy telephony network by conveying an address of an Internet telephony endpoint in a legacy telephony protocol. In particular, a globally unique Uniform Resource Identifier (URI), referred to herein as a Universal Global Title (UGT), may be assigned as an address of the Internet telephony endpoint. The UGT address of the Internet telephony endpoint can then be conveyed to the legacy telephony network as an Internet Address Parameter (IAP), implemented as an extension to the American National Standards Institute (ANSI) ISDN User Part (ISUP) legacy telephony protocol. Any number of known techniques may be used to convey an address of a legacy telephony endpoint to the Internet telephony network. As a result, the Internet telephony network and the legacy telephony network may exchange addressing and/or other types of signaling information in an interoperable manner.

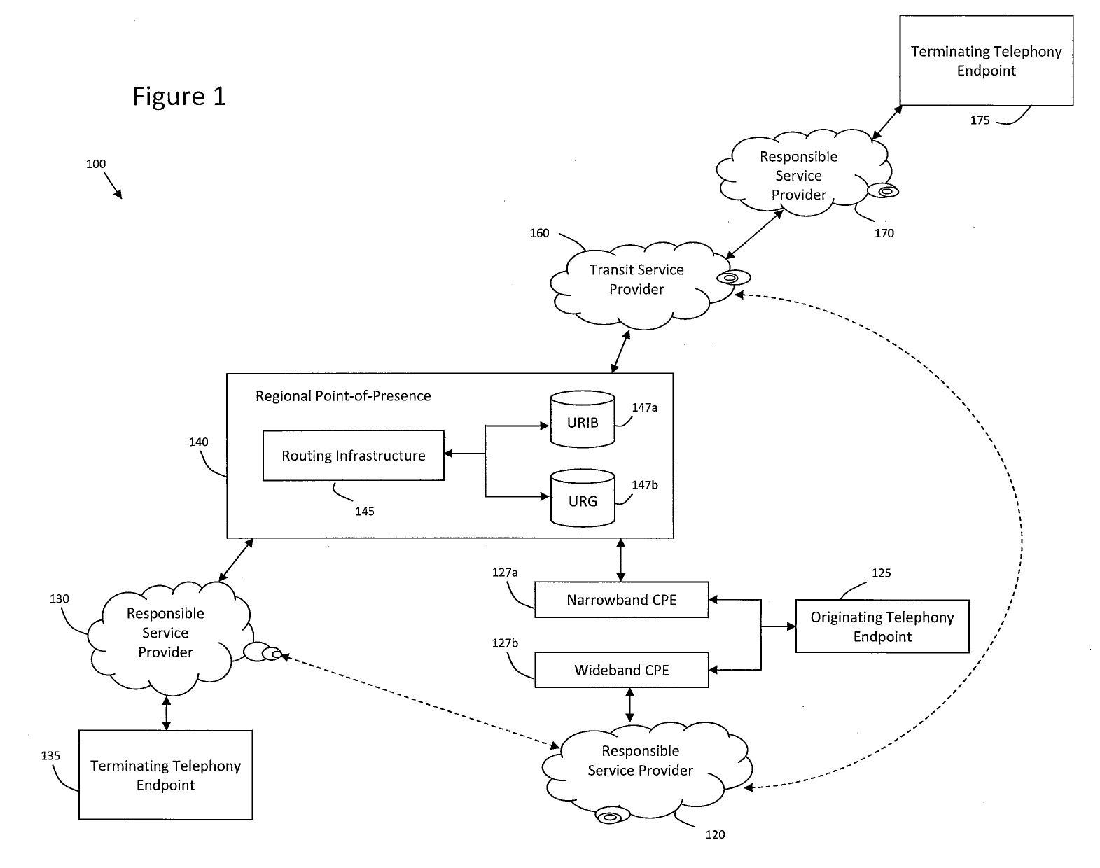

Various implementations of the invention include providing a Universal Teletraffic EXchange (UTEX) where Internet telephony networks and legacy telephony networks can interoperate with one another at a peer-to-peer level. The UTEX may also facilitate settlement-free traffic exchanges between service providers that register as members of the UTEX. For example, FIG. 1 illustrates an exemplary region 100 of the UTEX that includes at least one point of presence (POP) 140. The POP 140 may operate as a settlement-free exchange point where service providers having membership in the UTEX can exchange addressing and signaling information. The UTEX may therefore include a plurality of exchange points to provide a POP 140 in various geographically distributed regions. As a result, the UTEX may facilitate generally settlement-free transactions among member service providers, and may further ensure that signaling information will be preserved for delivery to a non-member local exchange carrier (e.g., in instances where a call session has an endpoint on the PSTN).

As discussed below, by passing the UGT to a service provider having responsibility for terminating call sessions with a terminating telephony endpoint, the UTEX may eliminate the aforementioned “Phantom Problem.” In particular, the “Phantom Problem” may be addressed through using addressing and signaling mechanisms that legacy telephony networks use to originate and terminate communications. Telephony service providers claiming to experience the “Phantom Problem” may register as a member of the UTEX or otherwise interconnect and exchange traffic with the UTEX. The UTEX will then provide the service provider with addressing and signaling information that identifies an origin and destination for the exchanged traffic, obviating the “Phantom” issue. On the other hand, when the service provider has no “Phantom” issues, the service provider may have no need to interconnect with the UTEX. As such, whether service providers become members of the UTEX may generally be considered voluntary, to the extent that participation may be necessary to satisfy demands for addressing and signaling information.

As indicated above, Internet telephony networks and legacy telephony networks may exchange traffic in the UTEX through an interoperable addressing scheme. The interoperable addressing scheme can therefore uniquely identify each telephony endpoint that communicates signaling information in the UTEX. As used herein, a telephony endpoint may generally include a network appearance that can initiate and receive messages and signals that relate to telephony services. Further, telephony endpoints deployed in the UTEX can include both Internet endpoints that establish telephony service using Internet Protocol (IP), as well as legacy endpoints that connect to the PSTN or the ISDN using Foreign Exchange Station (FXS) signaling. Telephony endpoints can therefore be either real or virtual in nature. As would be appreciated, a plurality of telephony endpoints can exist in any given platform.

The interoperable addressing scheme generally includes assigning a unique Universal Global Title (UGT) to each telephony endpoint with which the UTEX may communicate. The UGT for a given endpoint may include a variable length string encoded in accordance with the UTF-8 standard for a Uniform Resource Identifier (URI). The generality of the URI-based addressing scheme may allow legacy telephony endpoint addresses to be represented using any suitable technique. On the other hand, when communicating the UGT in an SS7 field or other legacy signaling stream, the UGT may be represented through an Internet Address Parameter (IAP) extension to the existing ANSI ISUP legacy protocol. To that end, the UGT and the IAP may collectively enable interoperability between IP-based telephony networks and legacy telephony networks, thus preserving peer-to-peer retail capabilities between and among different telephony service provider networks and technologies. Further details relating to the UGT and the IAP will be discussed in greater detail below, as the techniques used to communicate signaling information will first be explained in reference to FIG. 1.

As indicated above, the UTEX includes various geographically distributed settlement-free exchange points where telephony service provider networks can exchange signaling information and traffic with other service provider networks in a peer-to-peer manner. For example, as illustrated in FIG. 1, the UTEX includes at least one point-of-presence (POP) 140 in a telecommunications network region 100. The regional point-of-presence 140 represents a demarcation point or other interface between service provider networks that have registered as members of the UTEX.

As used herein, a member service provider refers to a telephony service provider that exchanges signaling information and traffic through a regional point-of-presence 140 of the UTEX, while a non-member service provider refers to a telephony service provider that does not exchange signaling information and traffic with the UTEX. Non-member service providers may also include telephony service providers that unsuccessfully attempt to exchange information with the UTEX or otherwise choose not to participate or register as members of the UTEX. For example, as shown in FIG. 1, service providers 120, 130, and 160 have interfaces to the regional point-of-presence 140, and may therefore be considered member service providers. On the other hand, a service provider 170 does not have an interface to the regional point-of-presence 140, and may therefore be considered a non-member service provider.

Furthermore, a service provider that has a direct customer relationship with a given telephony endpoint may be considered a responsible service provider supporting call sessions for that telephony endpoint. For example, as illustrated in FIG. 1, member service provider 120 may be considered the responsible service provider for telephony endpoint 125, member service provider 130 may be considered the responsible service provider for telephony endpoint 135, and non-member service provider 170 may be considered the responsible service provider for telephony endpoint 175. Member responsible service providers 120 and 130 may have various duties and responsibilities in the UTEX, including registering UGTs for the supported telephony endpoints 125 and 135 and providing settlement-free termination for the UGTs that the member responsible service providers 120 and 130 have registered.

When a call session terminates at a telephony endpoint 175 that a non-member responsible service provider 170 supports, another member service provider 160 may volunteer to represent the terminating endpoint 175 in the UTEX. The member service provider, for example, service provider 160 operating in this capacity, may be referred to as a transit service provider 160. The transit service provider 160 may also have various duties and responsibilities in the UTEX, including ensuring that addressing and signaling information, which includes at least the UGT, will be provided to the terminating responsible service provider 170. The transit service provider 160 may further be subject to a settlement regime that depends on a type of representation that the transit service provider 160 registers for the terminating telephony endpoint 175.

To minimize settlement charges for terminating call sessions, in various implementations of the invention, the UTEX may be configured to have all call sessions take place among member service providers 120, 130, and 160. The member service providers 120, 130, and 160 would therefore be required to adhere to specified standards for transmitting addressing and signaling information. As a result, member service providers 120, 130, and 160 may communicate with a legacy telephony service provider, whether a member of the UTEX or not, in a manner that can fulfill the legacy service provider's demands for signaling information needed to classify and rate call sessions based on telephony endpoint location, call session type, telephony endpoint user type, or technology employed by the user's responsible service provider, among other things.

In an exemplary illustration, a given call session in the UTEX occurs when an originating telephony endpoint 125 attempts to establish a call session with a terminating telephony endpoint. The call session may be generally be directed to either of a terminating telephony endpoint 135 supported by member responsible service provider 130, or to a terminating telephony endpoint 175 supported by non-member responsible service provider 170. Termination of the call session may be subject to differing settlement regimes depending on whether member service provider 130 or non-member service provider 170 supports the terminating endpoint, as will be discussed in greater detail below.

In either case, the originating telephony endpoint 125 attempts to establish the call session by initiating signaling with the UTEX. For example, the originating telephony endpoint 125 may initiate signaling with the UTEX by communicating a call control set-up message to the regional point-of-presence 140. In some implementations, the message may be communicated through narrowband customer premises equipment (CPE) 127a, sometimes referred to as customer-provided equipment. In some implementations, the originating telephony endpoint 125 may communicate the call control set-up message to its responsible service provider 120 through wideband customer premises equipment 127b. The responsible service provider 120 may then relay the message to the regional point-of-presence 140 to initiate signaling on behalf of the originating telephony endpoint 125 and subsequently deliver the call.

The call control set-up message may be received at the regional point-of-presence 140, either through the narrowband customer premises equipment 127a or an interface to the responsible service provider 120. The regional point-of-presence 140 includes a routing infrastructure 145 that extracts a globally unique UGT associated with the originating telephony endpoint 125 from the call control set-up message. Moreover, the call control set-up message further includes an identifier for the terminating telephony endpoint to be addressed in the call session. The identifier for the terminating telephony endpoint may or may not be represented as a UGT. For example, the message may provide a Called Party Number to identify the terminating telephony endpoint, in which case the routing infrastructure 145 constructs a UGT for the terminating telephony endpoint using the informational elements included in the call control set-up message.

When the routing infrastructure 145 has determined the UGT for the terminating end point, the routing infrastructure 145 may lookup the UGT in a Universal Routing Information Base (URIB) 147a. The Universal Routing Information Base 147a may include one or more databases that provide authentication, authorization, accounting, or other forms of information that can be used to manage signaling in the UTEX, including UGTs that member service providers 120, 130, and 160 have registered to support. As such, the routing infrastructure 145 may perform lookup the terminating telephony endpoint UGT in the Universal Routing Information Base 147a to determine an egress service provider to which the signaling information in the call control set-up message will be provided. For example, the egress service provider generally may include a member service provider that registered a UGT associated with the terminating telephony endpoint.

Once signaling has been established, traffic originating from telephony endpoint 125 may be routed from the responsible service provider 120 to the egress service provider, which handles termination at the terminating telephony endpoint identified in the call control set-up message. For instance, the information in the Universal Routing Information Base 147a may be exported to a Universal Routing Guide (URG) 147b, which includes various parameters that the routing infrastructure 145 uses to establishing routing from ingress service providers to egress service providers. Moreover, the Universal Routing Guide 147b may be dynamically distributed among member service providers 120, 130, and 160 to ensure availability of current routing information throughout the UTEX. The Universal Routing Guide 147b may be distributed to the member service providers 120, 130, and 160 at any suitable interval, including monthly, daily, in real-time, or otherwise.

Using the UGTs for the originating telephony endpoint 125 and the terminating telephony endpoint, the routing infrastructure 145 may apply one or more route selection policies to select an egress service provider from one or more of the Universal Routing Information Base 147a or the Universal Routing Guide 147b. For example, the call control set-up message may identify a terminating telephony endpoint 135 that a member responsible service provider 130 supports. In such cases, the selected egress service provider would be the member responsible service provider 130 that has registered the UGT for terminating telephony endpoint 135. The routing infrastructure 145 would therefore pass signaling information to the terminating member responsible service provider 130, which may be required to terminate traffic directed from the originating telephony endpoint 125 to the terminating telephony endpoint 135 without settlement.

In some implementations, the call control set-up message may identify a terminating telephony endpoint 175 that a non-member responsible service provider 170 supports. In such cases, a member service provider 160 may accept responsibility for terminating the call with the non-member responsible service provider 170. Thus, although the member service provider 160 does not directly support the terminating endpoint 175, the member service provider 160 would nonetheless have registered support for a UGT associated with the terminating endpoint 175. As such, the member service provider 160 operates as a transit service provider that terminates signaling and exchanges traffic with the eventual responsible service provider 170. Because the transit service provider 160 handles signaling and traffic exchanges with a non-member service provider 170, the transit service provider 160 may be provided with a flexible settlement regime for termination.

In particular, the transit service provider 160 can register support for a UGT associated with the telephony endpoint 175 that the non-member responsible service provider 170 directly supports. The transit service provider 160 may register a “degenerate” UGT identical to that of the terminating telephony endpoint 175, essentially registering as a proxy for the eventual responsible service provider 170. In this case, the transit service provider 160 may be required to handle termination from the originating telephony endpoint 125 to the terminating telephony endpoint 175 without settlement. In some implementations, the transit service provider 160 can register a UGT that only relates to that of the terminating telephony endpoint 175 without being identical thereto. In this case, the transit service provider 160 may be permitted to terminate with a settlement charge, although it will be apparent that the transit service provider 160 may choose to terminate without settlement.

Regardless of whether the transit service provider 160 has registered the degenerate UGT or the related UGT, the transit service provider 160 may be free to negotiate settlements for termination with the eventual responsible service provider 170. However, the negotiated settlements between the transit service provider 160 and the eventual responsible service provider 170 would remain independent of the generally settlement-free billing scheme employed in the UTEX.

Passing the UGT of the originating telephony endpoint 125 to the terminating responsible service provider 170 may be considered necessary in some implementations to preserve signaling information that a local exchange carrier demands. When the transit service provider 160 handles termination for the terminating telephony endpoint 175, the transit service provider 160 may be required to unconditionally pass the UGT of the originating telephony endpoint 125 to the terminating responsible service provider 170. In some implementations, should the transit service provider 160 fail to comply with the requirement to pass the UGT of the originating telephony endpoint 125 to the terminating responsible service provider 170, the membership of the non-complying transit service provider 160 may be suspended until proper compliance has been achieved.

Additionally, in some implementations, the UTEX may generally prohibit unsolicited calling or voice spam, and as such, Unsolicited Calling Providers or Voice Spammers may not directly exchange traffic with the UTEX. Even though legal rules and regulations may not necessarily impose requirements or prohibitions regarding voice spam control, practical considerations tend to indicate that public policy regarding appropriate use of new technology lags abilities of the new technology. As such, the UTEX may be implemented to enforce a policy that prohibits member service providers from exchanging voice spam traffic, although member service providers, the FCC, or other administrative bodies having appropriate rulemaking authority may establish additional policies that supplement or preempt voice spam controls.

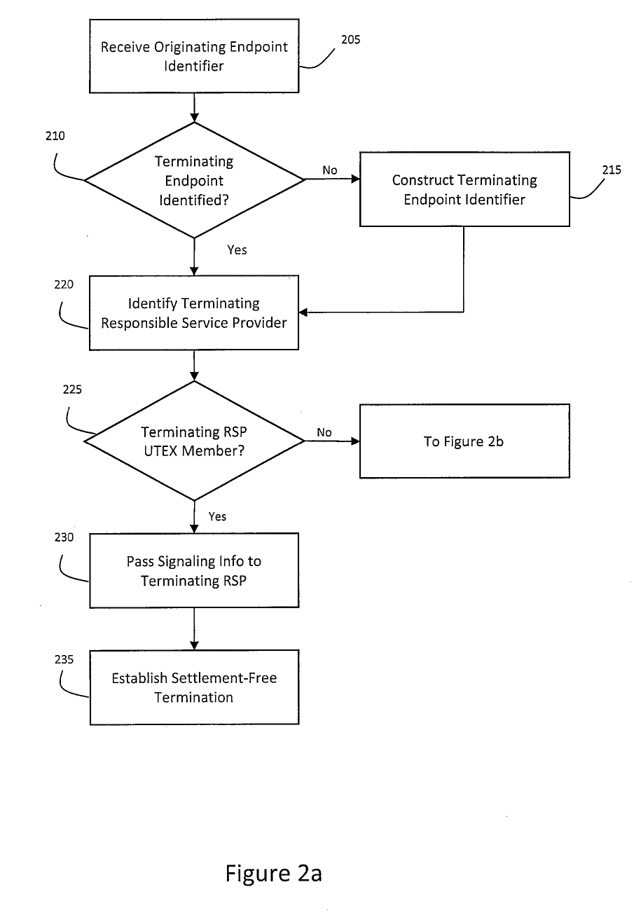

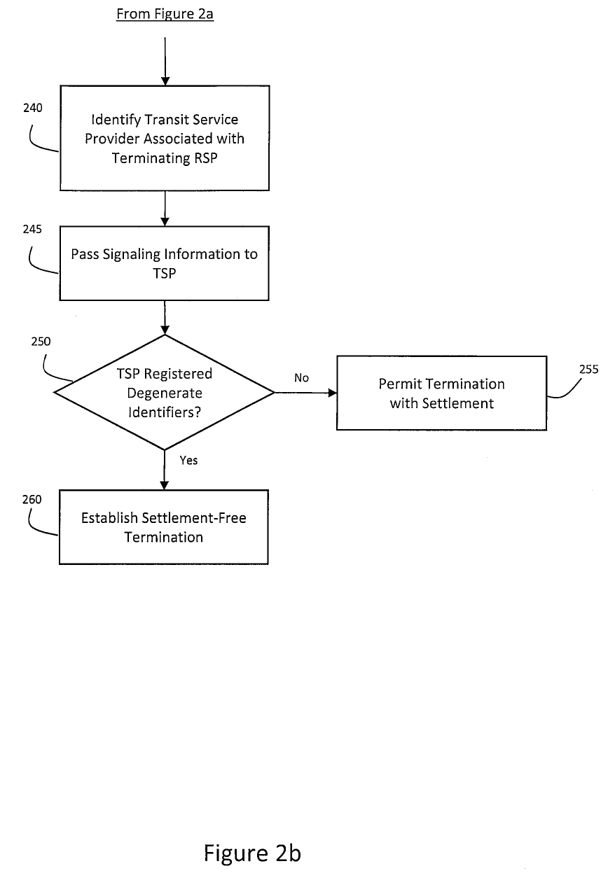

FIGS. 2a-b provide a flow diagram illustrating an exemplary method for routing signaling information among member service providers to establish a call session in the UTEX. For a given call session, an operation 205 may include an originating telephony endpoint attempting to establish a call session with a terminating telephony endpoint. A call control set-up message may be received, for example, at a regional point-of-presence. A globally unique UGT associated with the originating telephony endpoint may be extracted from the call control set-up message. Operation 210 may determine whether the call control set-up message includes a globally unique UGT for the terminating telephony endpoint.

When the call control set-up message does not include a globally unique UGT for the terminating telephony endpoint, the terminating telephony endpoint may nonetheless be identified in the call control set-up message. For example, the message may include a Called Party Number that identifies the terminating telephony endpoint. Operation 215 may thus construct a globally unique UGT for the terminating telephony endpoint, for example, using various informational elements that may be included in the call control set-up message.

When the UGT has been constructed or otherwise identified for the terminating end point, a terminating responsible service provider may be identified in operation 220. The terminating responsible service provider may be identified by looking up the UGT for the terminating telephony endpoint in the Universal Routing Information Base (URIB). Operation 220 may include identifying the terminating responsible service provider to determine an egress service provider. The egress service provider receives the signaling information in the call control set-up message, and generally includes a member service provider that registered a UGT associated with the terminating telephony endpoint. Thus, when a decisional operation 225 determines the terminating responsible service provider to be a member of the UTEX, the signaling information may be passed to the terminating responsible service provider in an operation 230. The terminating responsible service provider may deliver the call to the terminating endpoint, and settlement-free termination may be established for the call in an operation 235.

When decisional operation 225 determines the terminating responsible service provider to not be a member of the UTEX, a transit service provider associated with the terminating responsible service provider may be identified in an operation 240. The signaling information may be passed to the transit service provider in an operation 245. Because the transit service provider handles signaling and traffic exchanges with the non-member terminating responsible service provider, a decisional operation 250 may determine whether the transit service provider can terminate with or without settlement. In particular, as discussed above, the transit service provider may register a “degenerate” UGT identical to that of the terminating telephony endpoint, essentially registering as a proxy for the terminating responsible service provider. In this case, an operation 260 may include establishing settlement-free termination from the transit service provider to the terminating telephony endpoint. When the transit service provider registers a UGT that only relates to that of the terminating telephony endpoint, without being identical thereto, an operation 255 may include permitting the transit service provider to terminate with settlement charges, although it will be appreciated that the transit service provider may terminate without settlement in such cases as well.

The following description provides further detail regarding the implementation and the UGT and techniques that may be used to represent an IP-based signaling identified in a legacy telephony protocol. More specifically, as discussed above, a globally unique Universal Global Title (UGT) may be assigned to each telephony endpoint with which the UTEX can establish a call session. The Universal Global Title for a given telephony endpoint may include a variable length string encoded as a Uniform Resource Identifier, and has a general format of “user-part@domain-part.” When interpreting a UGT, the UTEX may disregard any internal structure or semantics that may be contained in either of the “user-part” or the “domain-part,” instead interpreting the UGT in a bit-wise manner. For example, the domain-part of a given UGT need not have an interpretation in the Domain Name System (DNS), although service providers registering for membership in the UTEX may reserve a limited number of domain-part identifiers for the registering service providers' exclusive use.

Member service providers may generally assign UGTs to the telephony endpoints for which the member service providers have direct termination responsibility. The assigned UGTs may be required to conform to the generic syntax for a Uniform Resource Identifier, as defined by the Internet Engineering Task Force (IETF). Further, the assigned UGTs may then be registered with the UTEX, which may verify that each registered UGT represents a globally unique variable length string in the Universal Routing Information Base (URIB) and Universal Routing Guide (URG). Furthermore, a member service provider may choose to register UGTs for which other service providers have direct termination responsibility. In this capacity, the member service providers may be registering as transit service providers willing to accept responsibility for termination with the service provider actually responsible for the registered UGTs. Moreover, the UGTs registered in a transit capacity may be identical or merely related to the UGTs actually associated with the telephony endpoints. As discussed above, the transit service provider may be subject to a settlement scheme that depends on whether the transit service provider registers degenerate UGTs identical to those of the supported telephony endpoints or UGTs merely related to those of the supported telephony endpoints.

Further, as indicated above, a service provider's participation in the UTEX may be considered voluntary. The UTEX may therefore generate UGTs to uniquely represent telephony endpoints for which non-member service providers have termination responsibility. For example, the UGTs generated for a non-member responsible service provider may include a domain-part considered appropriate for that responsible service provider. The domain-part may be solicited from the non-member service provider, which may provide a preferred domain-part to be used in the generated UGTs. However, when the non-member service provider does not provide a preferred domain-part, the UTEX may automatically construct a domain-part for the non-member network. For instance, when the non-member service provider has a generally accepted domain name in the DNS, the generated UGTs may include a domain-part based on the generally accepted domain name.

When the non-member service provider does not have a generally accepted domain name, the generated UGTs may include a domain-part derived from the Local Exchange Routing Guide (LERG). The Local Exchange Routing Guide includes a comprehensive database of routing data for local exchange carriers and other telecommunications carriers within the North American Numbering Plan (NANP). For example, the Local Exchange Routing Guide includes information that inter-exchange carriers (IXCs) may use to route calls over the PSTN. As such, in generating UGTs for a non-member service provider that does not have a generally accepted domain name, the UTEX may identify an Operating Company Number (OCN) for the service provider in question from Local Exchange Routing Guide. The domain-part would therefore be represented as “UTEX-OCN-XXXX,” where the identified Operating Company Number populates the “XXXX” portion of the domain-part. However, when the Operating Company Number cannot be identified for the service provider, the domain-part may be represented as “UTEX-NOOCN-XXXX,” where the UTEX orders the “XXXX” field sequentially and in a manner unique to the particular non-member service provider not having a domain name or Operating Company Number.

The generated UGTs may then be inserted into the Universal Routing Information Base and identified as not having an egress route. Moreover, the UGTs inserted into the Universal Routing Information Base may be marked as inactive until if and when the non-member responsible service provider becomes a UTEX member. Thus, when the non-member responsible service provider becomes a UTEX member and initiates representation of the UGTs, the UGTs may then be marked active and identified as having an egress route. The UTEX may therefore ensure interoperability with non-member service providers that cannot or choose not to register as members of the UTEX. As a result, the UTEX may nonetheless support call sessions that terminate with non-member service providers, although termination of such call sessions may be subject to settlement charges.

The UTEX therefore provides a mechanism for disambiguating the nature of a originating telephony endpoint for call sessions that routed through the UTEX. To that end, the UTEX may require that member service providers pass a UGT of the originating endpoint to an eventual responsible service provider, even if the eventual responsible service provider does not participate in the UTEX. Further, as mentioned above, a transit service provider may be required to pass the originating endpoint UGT to the responsible service provider for the terminating endpoint. In some implementations, addressing and other signaling information may be transferred to egress service providers that employ IP-based telephony protocols. For example, for call sessions established using Session Initiation Protocol (SIP), network elements passing the originating UGT may simply place the UGT in a Request Uniform Resource Identifier for a Session Initiation Protocol transaction.

In some implementations, when an egress signaling path involves a legacy telephony network, other techniques may be employed to convey the URI-based Universal Global Title in accordance with a legacy telephony protocol. Specifically, for transfers traversing SS7 ISDN User Part (ISUP) networks, consideration may be given to criteria associated with the protocols generally employed therein. More specifically, the original design of the ISUP protocol was envisioned to provide sufficient extensibility to accommodate various future technologies, wherein the American National Standards Institute (ANSI) has defined various stipulations to standardize extensions to the ISUP protocol.

For example, the ANSI stipulations generally require existing protocol elements (e.g., procedures, messages, parameters, and codes) to remain unchanged unless necessary to correct a protocol error or to change operations, services, or capabilities of a network employing the protocol. Furthermore, semantics associated with messages, parameters, or fields within a parameter should not be changed, nor should rules for formatting and encoding messages be modified. Additionally, parameters cannot be added to mandatory portions of an existing message, but parameters may be added to an optional portion of an existing message. However, when parameters need to be added to the mandatory portion of an existing message, a new message can be created and the new message may contain the desired combination of existing and new mandatory parameters. Similarly, new octets should not be added to an existing mandatory fixed length parameter, but optional parameters can be defined to contain the desired set of information fields. Field sequences in existing variable length parameters should remain unchanged, although new fields may be added after the existing sequence of parameter fields. However, a new parameter should be defined to implement a required change to the sequence of parameter fields. Finally, the all zeros code point should be reserved exclusively for indicating an unallocated, spare, or otherwise insignificant value of a parameter field, thus avoiding one version of the protocol from sending an all zeros code as a spare value that another version of the protocol could interpret as being a significant value.

Despite the numerous stipulations to extending the ISUP protocol, the ANSI ISUP specification provides a Generic Address Parameter (GAP) capable of conveying a URI-based address. In North America, for example, the GAP parameter has been used to implement local number portability (LNP) in order to permit existing telephone numbers to be reassigned from one local exchange carrier to another. However, existing network equipment implementing local number portability generally falls short in taking full advantage of the potential extensibility of the ISUP protocol. Specifically, existing switching equipment designed in compliance with local number portability treats messages containing multiple GAP parameters as a protocol violation, even though the protocol does not explicitly forbid such messages.

As a result, various implementations of the invention include a parameter that extends the ISUP protocol. The parameter, which may be referred to as an Internet Address Parameter (IAP), enables the UTEX or a transit service provider to provide the UGT of an originating endpoint to a non-member service provider that employs SS7-based switching elements. The IAP may be passed as an additional parameter, and therefore does need not to be substituted for any other parameter that may currently be required for interoperability or signaling under industry standards or FCC regulations. As such, by passing the IAP independently, the UTEX may provide interoperability with switching elements that cannot otherwise interpret a URI-based identifier such as the Universal Global Title. Thus, legacy switching elements can choose to ignore the additional IAP without affecting call processing, although a service provider that configures equipment to ignore the IAP will be discarding signaling information that the UTEX provides to satisfy local exchange carriers' stated desire and need for such information.

As indicated above, the UTEX provides interoperability between IP-based telephony networks and non-member legacy telephony networks by conveying a URI-based address in an Internet Address Parameter (IAP) extension to a legacy protocol. More particularly, the IAP represents a variable-length optional parameter that extends the ISUP protocol. In general, ISUP messages identify parameters according to parameter name codes defined according to eight bit words (e.g., a Called Party Number parameter may be represented as “00000100,” a Calling Party Number parameters may be represented as “00001010,” etc.). As such, the word representing the IAP in the ISUP protocol may include any suitable and otherwise unassigned code point. For example, the UTEX may provisionally employ a currently unassigned code point of “11001000,” although it will be apparent that relevant standard bodies may formally assign any suitable unassigned code point to the IAP. However, the unassigned code point of “11001000” may be preferred because it provides consistency with current usage, as it formally follows code points of the Generic Address Parameter and Generic Name Parameter.

Universal Global Titles or other URI-based identifiers may be encoded as an Internet Address Parameter according to a particular scheme. Specifically, one or more eight bit octets represent the UGT identifier, as follows:

| | | | | | | | |
|---|---|---|---|---|---|---|---|
| 8 | 7 | 6 | 5 | 4 | 3 | 2 | 1 |

| | | |
|---|---|---|
| Odd/Even | Screening Indicator | Nature of Address Indicator |

First UTF-8 Octet
. . .
Nth UTF-8 Octet

In the above-provided encoding scheme, the Odd/Even bit indicates whether a number of octets conveying the UGT has odd or even multiplicity (e.g., a ‘1’ can indicate an odd multiplicity, and a “0” would thus indicate an even multiplicity).

The Screening Indicator bits may address interoperability issues relating to anonymity. Specifically, FCC rules and regulations generally require carriers to preserve a Calling Party Number (CPN) for presentation to downstream carriers. However, in legacy telephony networks, an SS7 parameter permits a calling party to indicate whether to keep a calling name or number private from the called party. When the SS7 privacy parameter has been flagged, FCC rules and regulations further require a terminating carrier to suppress delivery of the Calling Party Number to the called party, unless the called party qualifies within a specific customer classification permitted to obtain private information. As such, Internet Address Parameter can be used to pass the Calling Party Number to legacy responsible service providers in accordance with FCC regulations, while the Screening Indicator can indicate whether the UGT of the calling party can be presented to a terminating endpoint or called party. For example, a “01” may be included as the Screening Indicator bits to permit presentation, a “10” may disallow presentation, and “00” and “11” may be reserved. Enforcement of the Screening Indicator may generally be within the jurisdiction of the UTEX, although other regulatory or administrative bodies may establish further rules or procedures.

With respect to the Nature of Address Indicator bits, these bits may be employed to specify the nature of an address represented by the IAP. For example, a “00001” code point may indicate that the IAP represents a Universal Global Title, as described herein, while “00000” and “11111” may represent reserved code points and other code points have no interpretation. Subsequent octets of the IAP may then represent a binary encoding of the UGT identifier for an originating endpoint. As a result, the IAP may encode UGT for the originating point in accordance with the ANSI ISUP legacy protocol, providing compatibility with legacy telephony service provider networks.

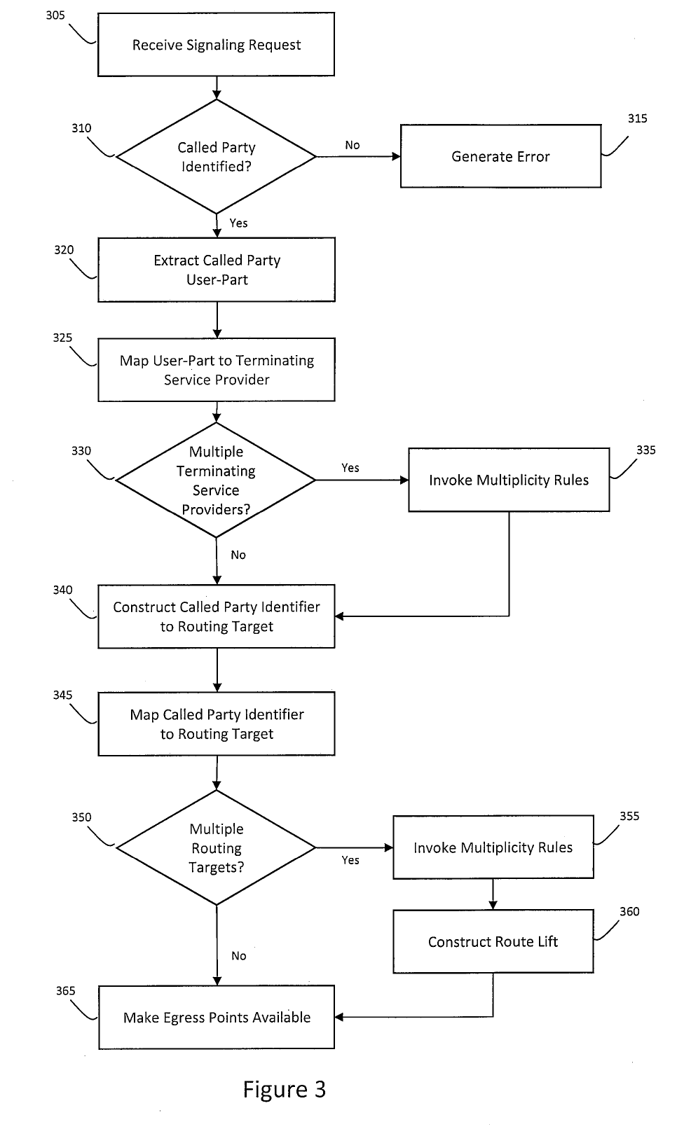

According to various implementations of the invention, FIG. 3 illustrates an exemplary method for establishing routing information between an originating telephony endpoint and a terminating telephony endpoint, which may also referred to as a calling party and a called party, respectively. For example, signaling information may be exchanged in a Universal Teletraffic EXchange (UTEX) in the manner discussed above, such that originating and terminating responsible service providers can identify signaling information associated with a call. Thereafter, the method illustrated in FIG. 3 may be employed to establish routes for traffic exchanged between the calling party and the called party.

Routing flow may be established using information contained in a Universal Routing Guide (URG). The Universal Routing Guide includes associations between Universal Global Titles (UGTs) that uniquely identify telephony endpoints and member service providers that have registered representation of the UGTs. Member service providers may receive the Universal Routing Guide at periodic intervals, thus ensuring that member service providers have up-to-date routing information. Furthermore, as indicated above, the Universal Routing Guide may be populated using information contained in a Universal Routing Information Base (URIB). Member service providers may therefore also receive up-to-date routing information by performing a real-time query of the Universal Routing Information Base. For example, member service providers may use Session Initiation Protocol (SIP) NOTIFY or SUBSCRIBE messages to receive updates to the Universal Routing Guide or query the Universal Routing Information Base. As such, the Universal Routing Guide and the Universal Routing Information Base may include various forms of information used to establish signaling and routing from an ingress member service provider to an egress member service provider.

As illustrated in FIG. 3, the UTEX may begin to establish routing in an operation 305, where a signaling request may be received from a calling party. The signaling request includes a UGT for the calling party and identifies a party with which a call session may be desired. Further, when the ingress service provider employs a legacy signaling protocol such as SS7 or ANSI ISUP, the ingress service provider would provide the UGT for the calling party as an Internet Address Parameter. Target analysis may then be initiated in an operation 310, which includes extracting a UGT for the called party from the signaling request.

When the UGT for the called party cannot be extracted or otherwise identified, the UTEX may be unable to identify a suitable egress member service provider with which to exchange signaling and routing information. Thus, in instances where the UGT for the called party cannot be identified, the UTEX may immediately release the call and generate an error message in an operation 315. The error message may be provided to an originating service provider having responsibility for the calling party. Moreover, the error message may be formatted in accordance with a type of network associated with the originating service provider. For example, a “01—Unallocated” error message may be generated for originating ISDN networks, while a “404” error message or equivalent cause code may be generated for originating SIP networks.

When the UGT for the called party has been successfully extracted from the signaling request, a routing target may then be determined. For example, determining the routing target may include an operation 320 for extracting a user-part for the called party from the UGT identified in operation 310. In particular, when the ingress service provider initiates signaling on behalf of the calling party in operation 305, the ingress service provider may utilize information in one or more of the Universal Routing Guide or the Universal Routing Information Base to identify a UGT for the called party. As such, the UGT for the called party may include a user-part and a domain-part constructed from the information in one or more of the Universal Routing Guide or the Universal Routing Information Base, wherein the domain-part identifies one or more service providers that have registered a UGT associated with the called party.

For instance, the UTEX may utilize various wildcard domain-parts to represent member service providers. The wildcard domain-parts generally include global wildcards that can represent either of transit service providers or responsible service providers, as well as wildcards that only represent responsible service providers. In some implementations, the global wildcards may be presented in a format of “UTEX-GLOBAL-XXX,” where “XXX” represents a code, for example a numeric code from 000 to 999, which corresponds to an eventual responsible service provider. In some implementations, the wildcards for responsible service providers only may be presented in a format of “UTEX-RSP-XXX,” where “XXX” similarly represents a code, for example a numeric code from 000 to 999, which corresponds to an eventual responsible service provider. As such, operation 320 includes comparing the domain-part of the UGT for the called party, as identified in operation 310, to the wildcard domain-parts. When the domain-part of the UGT for the called party matches one of the wildcard domain-parts, the domain-part may then be removed from the called party UGT, yielding a resultant user-part.

In some implementations, when the ingress service provider uses a legacy protocol such as ANSI ISUP to initiate signaling, the user-part would be the only extractable information relating to the called party. For example, when an ISUP message traverses an IP-based network, IP-based network elements may use various techniques to make routing decisions based on ISUP criteria such as the Called Party Number. Thus, when the ingress service provider employs a legacy protocol, operation 320 may include using such techniques to extract a user-part for the called party from the ingress protocol.

Operation 325 may include mapping the user-part to a service provider responsible for terminating a call session at the called party. The terminating service provider may be a member responsible service provider having a direct customer relationship with the called party, or a member transit service provider that has registered support for terminating with the called party. Operation 325 may therefore query a legacy lookup engine (LLE) to map the extracted user-part to a suitable terminating service provider.

For example, the legacy lookup engine may be populated with sixteen digit prefixes that correspond to entries in the Local Exchange Routing Guide (LERG) or other legacy routing guides. The Local Exchange Routing Guide includes various forms of information that can be used in making routing decisions, including Operating Company Numbers, Destination Codes, Location Routing Numbers, and Access Tandem Codes, among other things. Thus, the Local Exchange Routing Guide may provide current and comprehensive routing information relating to local exchange networks in the North American Numbering Plan. Moreover, the legacy lookup engine may include representations of one or more member service providers, including UGTs for which the member service providers have registered termination support. As such, the legacy lookup engine logically links user-parts for which member and non-member service providers provide termination support.

By populating the legacy lookup engine with information from the Local Exchange Routing Guide and representations of member service providers, operation 325 may be used to identify one or more domain-parts that correspond to service providers capable of providing termination with the called party. The domain-parts identified in operation 325 may include one or more of domain-parts for member responsible service providers, non-member responsible service providers, or member transit service providers. For example, when the domain-part of the called party matched a wildcard only for responsible service providers, operation 325 would likely return a domain-part for a member or non-member responsible service provider. However, when the domain-part of the called party matched a global wildcard, operation 325 could also return a domain-part for one or more member transit service providers.

Operation 330 may include determining whether operation 325 returned multiple terminating service providers, in which case an operation 335 would include invoking one or more multiplicity rules to select one of the terminating service providers. For example, because fewer traffic exchanges would be required for responsible service providers, and because member responsible service providers would provide settlement-free termination with the called party, the multiplicity rules may generally reflect a preference for responsible service providers over transit service providers.

When the responsible service provider has not registered as a UTEX member, however, one of the transit service providers may be selected. For example, the multiplicity rules may define a preference based on geographical proximity, as communication overhead may be less for geographically local transit service providers than geographically remote transit service providers. Further, a transit service provider that has registered degenerate UGTs may be required to provide settlement-free termination, and may therefore be favored over a transit service provider that has registered non-degenerate UGTs. Further still, the ingress service provider may specify a preference for a certain transit service provider (e.g., because the transit service provider has terminated previous call sessions reliably). However, when the multiplicity rules fail to establish an adequate preference, the terminating member service provider may be selected in a manner that distributes traffic to a coldest member service provider (e.g., a first-in-first-out routing allocation).

A fully qualified UGT may be constructed for the called party in operation 340. In particular, the user-part of the called party extracted in operation 320 may be combined with the terminating service provider selected in operations 330 and/or 335. Operation 340 may therefore include constructing a UGT for the called party that corresponds to an active UGT that one or more member service providers have registered to support. In an operation 345, the UGT for the called party may be mapped to one or more member service providers that can operate as a suitable routing target. Specifically, the fully qualified UGT for the called party may be looked up in one or more of the Universal Routing Information Base or the Universal Routing Guide. For example, because one or more member service providers would have registered an active UGT that corresponds to the fully qualified UGT, operation 345 would identify such member service providers as routing targets suitable for handling traffic originating from the calling party and directed to the called party.

As in the case of operation 330, when multiple routing targets have been identified, an operation 350 may similarly invoke the multiplicity rules in an operation 355. The multiple routing targets may be arranged in an ordered list based on preferences determined from the multiplicity rules, including a preference for a member responsible service provider over member transit service providers. Depending on various circumstances, the multiplicity rules may be varied to determine preferences in other ways, as would be apparent. Upon ordering the multiple routing targets in an order of preference based on the multiplicity rules, an operation 360 may include constructing an ordered route list.

The ordered route list may represent an ordered collection of member service providers with which the ingress service provider can exchange traffic originating from the calling party and directed to the called party. An operation 365 may include the UTEX maintaining real-time availability of an egress point for each route in the ordered route list. When operation 350 determines that only one suitable routing target has been identified, the egress point made available in operation 365 would correspond only to that one routing target. The UTEX may therefore facilitate routing from the ingress service provider to one or more routing targets in an order of preference, where the routing targets include member service providers that have registered support for termination with the called party.

In some implementations, when a preferred egress point becomes unavailable for any reason, a subsequent egress point in the route list may be selected automatically. When each egress point in the route list becomes unavailable, an error message may be returned to the ingress service provider to indicate that the call has failed. For calls that originate on the PSTN, the ISDN, or another legacy network, the error message may include “34—No circuit available.” On the other hand, for calls that originate from a SIP network or another IP-based network, a “503” error message or equivalent cause code may be returned.

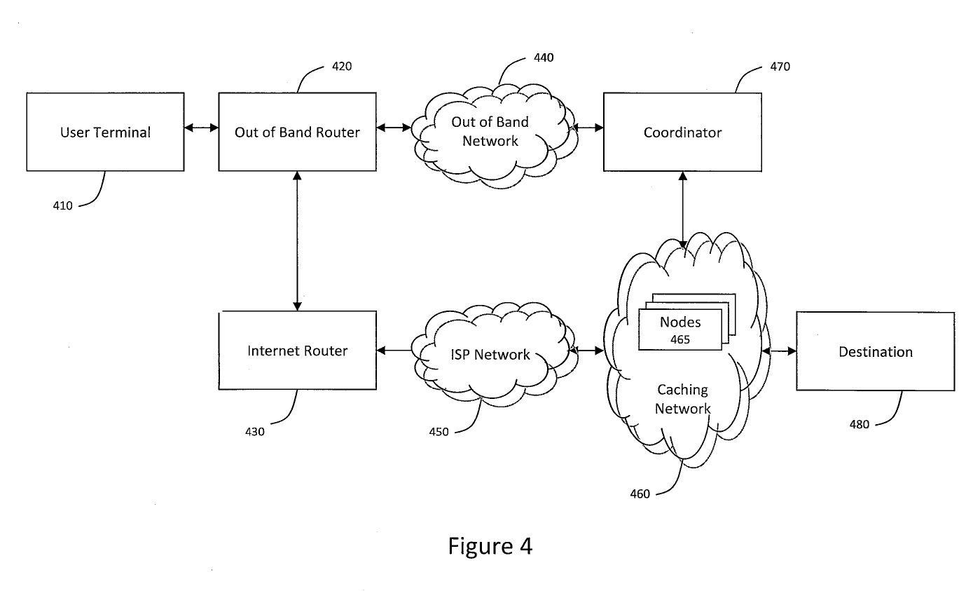

According to various implementations of the invention, the aforementioned mechanisms for enabling interoperability among IP-based telephony networks and legacy telephony networks may facilitate peer-to-peer services and applications to be implemented across interoperable service provider networks. For example, as illustrated in FIG. 4, usage of any suitable wideband service provider network, whether public or private, may be controlled through secure out of band signaling. Therefore, out of band signaling over licensed or unlicensed spectrums may support real-time and non-real-time wideband communications at a peer-to-peer level.

To that end, the UTEX may be allocated or otherwise deployed in connection with an out of band signaling network 440, which can interoperate with various wideband networks 450 capable of supporting real-time or delayed applications, including voice, video, chat, data, or other multimedia. The UTEX may therefore provide secure out of band signaling to control utilization of wideband public or private Internet networks 450, regardless of connectivity options that may be associated therewith. Furthermore, identity control may be provided for wideband network communications through narrowband out of band signaling, allowing natural formation of peer-to-peer networks that rely on user control. For example, users may form a peer-to-peer network for communications over the wideband network 450, where the out of band signaling network 440 establishes call sessions between nodes of the peer-to-peer network.

Further, in an environment that provides peer-to-peer signaling, application developers may be empowered to create tools and applications having public and secure signaling support. As a result, applications controlled by the out of band signaling network 440 may provide identity-based permissions to control communications for a given user, node, telephony endpoint, or other communications entity. For example, the out of band signaling network 440 may initialize communications path between endpoints, and may further control content for allowed or disallowed communications via signaling identifiers (e.g., Universal Global Titles that provide an index to an identity management system). Moreover, the out of band signaling network 440 may provide reverse controllability, where a receiving node or endpoint can indicate that certain communications will be allowed or prohibited, or set requirements and gate checks to allow or prohibit certain types of communications.

In providing identity control over narrowband out of band signaling, a given use of a wideband public or private communications network 450 may be authenticated, measured, or otherwise identified and controlled. Similarly, usage of the wideband network 450 may be allocated and otherwise controlled for specific users, user groups, users within user groups, or any other suitable identity management technique. For example, databases associated with various wideband service provider networks may be distributed and made available to the out of bang signaling network 440. The out of band signaling network 440 may therefore provide identity control for wideband network usage, including IP-based and non-IP-based communications, through coordinated dips of the available distributed databases. As a result, the narrowband out of signaling network 440 can provide dynamic identity manipulation to identify application requests and codec usages, provide secure signal coding for point-to-point or point-to-multipoint IP-based communications, or otherwise manage network access using suitable identity management techniques.

In an exemplary illustration, FIG. 4 represents a narrowband out of band signaling environment that can control wideband network usage for a particular user network. Specifically, a user at a terminal 410 may connect to a narrowband out of band signaling network 440 to control usage of a wideband Internet service provider network 450. The out of band signaling network 440 may therefore support various applications that use signaling information to control use of bearer data services. For example, bearer data services generally include simple data transport services that provide routing and transmission of data between network termination points without subjecting the data to any processing other than that may be required to ensure transmission and routing.

Because bearer data cannot be used without signaling information, the out of band signaling network 440 removes intelligence and other signaling from a bearer load. The out of band signaling network 440 passes the intelligence and other signaling out of band, obviating user terminal 410 from having to request or gain permission for communications through “in band” signaling with a bearer service provider, such as Internet service provider 450. To that end, the out of band signaling network 440 can provide intelligence and signaling that supports various wideband network applications, including demand-side management of devices that relate to electric, water, gas, or other utility consumption. Additional applications may include secure peer-to-peer communications that enhance terrestrial multimedia applications, wireless voice data applications, or file sharing and downloading applications, among others

Furthermore, available “in band” resources may be optimized through out of band signaling. For example, a multi-mode phone may communicate with the out of band signaling network 440 and dynamically choose an operational mode or a target upstream service provider based on signaling criteria that the out of band signaling network 440 supplies in response. Because the out of band signaling network 440 supports authentication, identification, and measurement of usage of wideband networks, additional applications may include secure transaction management and billing based on events measured in relation to various ones of the aforementioned applications or other applications. For example, a provider of network 450 or a user of terminal 410 may be billed for peer-to-peer file sharing based on an amount of network bandwidth consumption or other criteria.

In an exemplary illustration, control of wideband network usage may be established through out of band signaling when a user terminal 410 initiates signaling with the out of band signaling network 440 through an out of band router 420. The user terminal 410 may also be coupled to a wideband Internet service provider network 450 through an Internet router 430. The Internet service provider may generally supply the Internet router 430 to the user terminal 410, while an out of band service provider supplies the out of band router 420 to the user terminal 410. The Internet router 420 interfaces with the wideband Internet service provider 450 through a high bandwidth or high bit-rate interface, while the out of band router 420 communicates with the out of band network 440 through an interface of low or variable bandwidth or bit-rate.

Generally speaking, the out of band service provider operates in a manner similar to that discussed above in regard to the UTEX. As such, the user terminal 410 can bypass undesirable or illegal access restrictions that the Internet service provider may have placed on traffic passing through the Internet router 430. For example, various Internet service providers have been charged with placing undesirable restrictions on access to peer-to-peer file sharing applications. Thus, establishing use of the Internet service provider 450 through out of band signaling may allow users to bypass such restrictions. For example, restrictions may be bypassed because the Internet service provider does not have access to messages transmitted over the out of band network 440. Instead, interfaces between the out of band router 420, the out of band network 440, and a coordinator 470 of the out of band network 440 may be restricted to a domain of an out of band service provider. Further, messages transmitted over the out of band interfaces do not transit the Internet service provider network 450, or the Internet in general. The out of band service provider can also guarantee security and integrity for messages that transit the Internet service provider network 450 and originate or terminate at the user terminal 410.

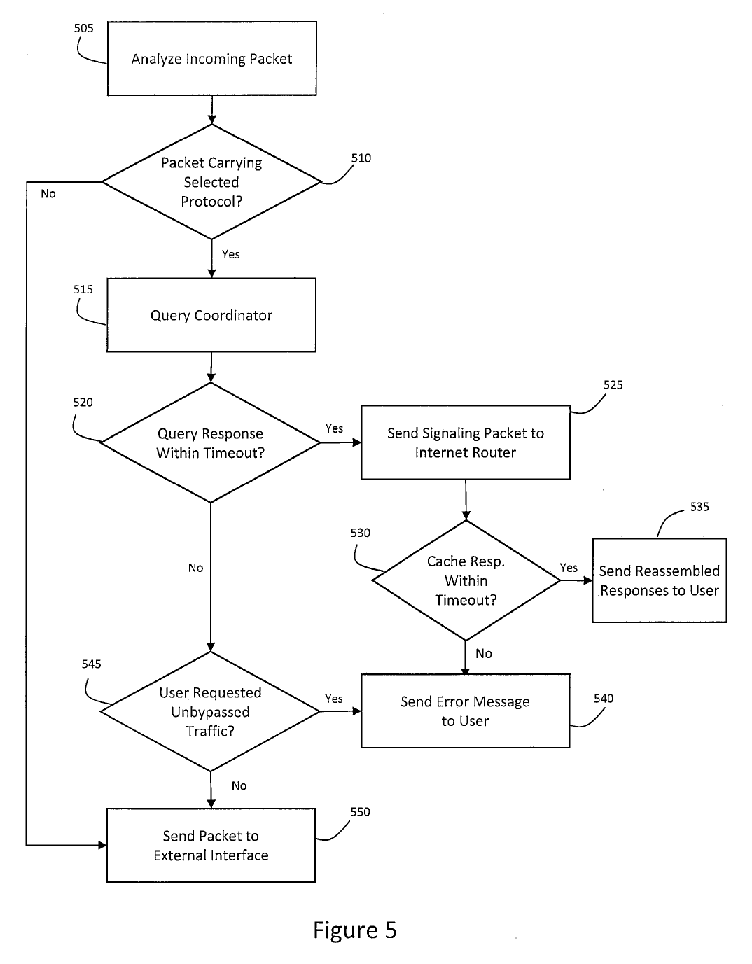

In various implementations of the invention, the out of band service provider may further enhance throughput and messaging capabilities for the user terminal 410. For example, the out of band service provider may dispose a caching network 460 to manage data transmitted between the user terminal 410 and a desired destination 480. In an exemplary illustration, FIG. 5 provides a method for initiating secure out of band signaling to control HyperText Transfer Protocol usage of wideband network 450. Although the exemplary implementations illustrated in FIGS. 4 and 5 includes the caching network 460, various implementations may nonetheless enable out of band signaling without necessarily including the caching network 460.

In the implementation illustrated in FIGS. 4 and 5, a user interacting with the user terminal 410 may request content associated with an IP-based destination 480, such as www.example.com. According to the techniques described in further detail herein, the user terminal 410 may receive data from the IP-based destination 480 without the Internet service provider network 450 receiving a request packet from the Internet router 430. Rather, in some implementations, the Internet service provider network 450 only receives packets flowing from the destination 480, the caching network 460, or another source, with such packets being directed to the address that the Internet service provider network 450 has assigned to Internet router 430.

Further, in various implementations, one or more of the out of band router 420, the out of band network 440, the Internet router 430, the Internet service provider network 450, and/or other components described herein may be associated with wireless networks and service providers. By coordinating signaling independently of wireless networks, a bearer load associated with data transmission may be divorced or otherwise decoupled from signaling, which may enable may peer-to-peer applications, such as point-to-point operating system sharing. Further, because signaling information may be hidden from a service provider network, wired or wireless network devices may communicate with one another without the service provider being able to sniff packets to restrict certain communication protocols or otherwise interfere with the flow of traffic.

For example, the aforementioned features may be enabled for a user terminal 410, which may initiate a request for content from the IP-based destination 480. The user terminal 410 may initiate the request by resolving an IP address of the destination 480, such as 1.2.3.4. The user terminal 410 may resolve the IP address of the destination 480 using a Domain Name System (DNS) service or another service for resolving IP addresses. When communicating using HyperText Transfer Protocol, the user terminal 410 would then send an HTTP GET message to the resolved IP address. As a result, a packet containing the message may include, among other things, the resolved IP address of the destination 480, an IP address of the user terminal 410 on a local area network, such as 10.10.10.10, a requested protocol, or other information.

Operation 505 may include the out of band router 420 receiving the packet including the GET message at an internal IP interface. The out of band router 420 then analyzes the incoming packet to determine whether the packet carries a protocol associated with the out of band signaling network 440. For example, the out of band router 420 may be configured to handle traffic for peer-to-peer protocols, file transfer protocols, or any other suitable protocol. When the packet does not carry a protocol that the out of band router 420 handles, a decisional operation 510 may cause the out of band router 420 to forward the packet directly to an external IP interface, such as the Internet router 430, in an operation 550. When the packet does carry an out of band signaling protocol, such as a peer-to-peer protocol, the out of band router 420 may initiate signaling with the out of band network 440. The out of band router 420 may therefore send a message to the out of band network 440 in an operation 515, where the message includes a query for execution at the coordinator 470.

A decisional operation 520 may include the out of band router 420 waiting to receive a response to the query message from the coordinator 470. For example, as indicated above, the coordinator 470 may initiate one or more coordinated database dips upon receiving the query message. The coordinated database dips may be employed to control the use of the wideband Internet service provider network 450, as requested in the packet received at operation 505, where a database dip generally refers to a query of a database associated with a wideband network provider or carrier.

For example, in an analogous use, incumbent local exchange carriers and other number portability providers often seek to recover costs of implementing Local Number Portability by charging requesting carriers on per database query or “dip.” The out of band signaling network 440 may or may not involve charges for database dips. The coordinator 470 may therefore attempt to establish signaling for a given wideband network use by authenticating one or more of an identity of the user of terminal 410, an identity of user groups to which the user belongs, an identity of the user terminal 410, a requested communication protocol, a requested destination, recent queries, or any other information that could relate to authentication, identification, measurement, or other signaling controls.

When the coordinator 470 does not provide a response to the query within a specified timeout period, decisional operation 520 may cause the out of band router 420 to enter an error treatment state in an operation 545. Specifically, in operation 545, the out of band router may determine whether the user has requested traffic that bypasses restrictions on usage of the wideband Internet service provider network 450. When the user has not requested unbypassed traffic, the packet may be forwarded to the external IP interface in an operation 550. In such cases, however, the user terminal 410 would remain subject to any access restrictions that the Internet service provider may have placed on traffic passing through the Internet router 430. On the other hand, when the user has requested unbypassed traffic, an error message may be returned to the user in an operation 540. The error message may indicate that the out of band router 420 was unable to establish out of band signaling, and the user may then reinitiate the request, troubleshoot an internal network, or otherwise act on the error message in order to set up out of band signaling.

When the out of band router 420 does receive a successful query response from the coordinator 470, however, an operation 520 may cause the out of band router 420 to enumerate one or more nodes 465 in the caching network 460. The enumerated cache nodes 465 may be identified as participants in delivering content from the destination 480 to the user terminal 410. To that end, an operation 525 may include the out of band router 420 sending one or more signaling packets to the Internet router 430. The signaling packets may prepare the Internet router 430 to accept incoming packets from the caching network 460, essentially serving to bypass a firewall and establish Network Address Translation (NAT) flows at the Internet router 430. For example, the signaling packets may include a source IP address identifying the out of band router 420 (e.g., 10.10.10.1). The signaling packets may further instruct the Internet router 430 to expect incoming packets from the enumerated caching nodes 465 on a randomized port. The enumerated caching nodes 465 may be identified, for example, using IP addresses that the coordinator 470 returns to the out of band router 420 in response to the query (e.g., 2.2.2.2, 3.3.3.3, 4.4.4.4, 5.5.5.5, etc.).

Accordingly, when the Internet router 420 subsequently receives incoming packets from the enumerated nodes 465 of the caching network 460, the incoming packets can traverse a firewall at the Internet router 430 and be received at the out of band router 420. Further, although the caching network 460 would provide the incoming packets to the Internet router 430 through the Internet service provider network 450, the Internet service provider network 450 would not have previously received or otherwise processed a request packet originating from the Internet router 430. Instead, the only packets traversing the Internet service provider network 450 would include the incoming packets flowing from the enumerated cache nodes 465 to an IP address that the Internet service provider assigned to the Internet router 430 (e.g., 5.6.7.8). As a result, a secure tunnel may be formed between the caching network 460 and the user terminal 410, bypassing any firewall that may exist at the Internet router 430.

More specifically, the coordinator 470 establishes out of band signaling upon receiving a successful response to the coordinated database dips or queries. The response to the coordinated database dips may therefore cause one or more of the cache nodes 465 to be enumerated. The coordinator 470 may then sends one or more messages to the enumerated cache nodes 465, which instruct the enumerated nodes 465 to retrieve the requested content from the destination 480 or other nodes 465 in the caching network 460. For example, the cache nodes 465 may be operable to send one or more packets to the destination 480 to retrieve content from the destination 480. The packets sent to the destination 480 would have an identical message format and destination IP address as the packet originally received at the out of band router 420 in operation 505. For example, the cache nodes 465 may send packets to the destination 480 that include an HTTP GET message directed to the destination IP address of 1.2.3.4. However, the packets would have a source IP address of one or more of the enumerated cache nodes 465 to ensure that the content will be received from the destination 480 at the cache nodes 465.

The cache nodes 465 essentially proxy one or more messages to the destination 480 on behalf of the user terminal 410. Further, the out of band router 420 communicates with the Internet router 430 to establish a secure tunnel between the caching network 460 and the user terminal 410. Operation 530 includes the out of band router 420 waiting for data to be received from one or more of the cache nodes 465. For example, upon receiving the requested content from the destination 480 or from other cache nodes 465, the cache nodes 465 may return one or more encrypted packets containing the requested content to the Internet service provider network 450. The encrypted packets would therefore traverse the Internet service provider network 450 and arrive at the Internet router 430.

The Internet router 430 then evaluates the encrypted packets in view of the NAT flows that the out of band router 420 previously established in operation 525. When the content arrives at the Internet router 430 through the Internet service provider network 450, the Internet router 430 forwards the content to the out of band router 420. Upon receiving the content within a specified timeout period, the out of band router 420 may decrypt and reassemble the packets received from the caching network 460 in an operation 535. The out of band router 420 then provides the reassembled packets to the user terminal 410 in accordance with the original requesting protocol. Thus, in some implementations, the protocol or other characteristics of incoming data may be hidden from both of the Internet service provider network 450 and the Internet router 430, allowing traffic restrictions to be bypassed.

When the out of band router 420 does not receive response packets from the caching network 460 within the timeout period, the out of band router 420 may send an error message to the user terminal 410 in operation 540 in a similar manner as described above. For example, the destination 480 may be overloaded with requests and unable to respond within a satisfactory period of time, and the request of the user terminal 410 may therefore timeout to release bandwidth or other network resources for requests that can be serviced. Various timeout techniques may be suitably employed in the out of band signaling system to optimize use of available wideband network resources.

Various implementations of the invention may be made in hardware, firmware, software, or various combinations thereof. The invention may also be implemented as instructions stored on a machine-readable medium, which may be read and executed by one or more processors or processing devices. For instance, the machine-readable medium may include various mechanisms for storing and transmitting information in a form readable by a machine (e.g., a computing device). For example, a machine-readable storage medium may include read only memory, random access memory, magnetic disk storage media, optical storage media, flash memory devices, and others, and a machine-readable transmission media may include forms of propagated signals, including carrier waves, infrared signals, and digital signals, among others. Further, firmware, software, routines, or instructions may be described in the above disclosure in terms of specific exemplary aspects and implementations of the invention, and performing certain acts or operations. It will be apparent, however, that such descriptions have been provided merely for convenience, and that the acts and operations described in fact result from computing devices, processors, controllers, or other devices executing the firmware, software, routines, or instructions.

Aspects and implementations may be described as including particular features, structures, or characteristics, but it will be apparent that various aspects or implementations may or may not include the particular features, structures, and characteristics. Further, when a particular feature, structure, or characteristic has been described in connection with an aspect or implementation, it will be understood that such feature, structure, or characteristic may be included in connection with other aspects or implementations, whether or not explicitly described. Thus, various changes and modifications to the preceding description may be made without departing from the scope or spirit of the invention, and the specification and drawings should therefore be regarded as exemplary only, and the scope of the invention to be determined solely by the appended claims.

What is claimed is:

1. A method for establishing peer-to-peer communications through secure out of band signaling, comprising:
receiving a message requesting content from a destination at a signaling device, wherein the message identifies an Internet address for the destination and a local area network address for a user terminal that initiated the request;
communicating a query to a signaling network to establish communications between the user terminal and the destination, wherein the signaling device receives a response to the query that enumerates one or more nodes, the enumerated nodes operable to proxy the message to the Internet destination on behalf of the user terminal;
establishing one or more Network Address Translation flows for the proxied message at an Internet router, wherein the Network Address Translation flows instruct the Internet router to accept incoming data from the one or more enumerated nodes, and to forward the incoming data to a local area network address for the signaling device;
receiving the requested content at the signaling device, wherein the enumerated nodes provide the requested content to the Internet router through at least one Internet service provider network, the Internet router operable to forward the requested content to the signaling device using the established Network Address Translation flows; and
providing the received content from the signaling device to the user terminal.

2. The method of claim 1, wherein the signaling device includes an out of band router communicatively coupled to the user terminal, the Internet router, and the signaling network.

3. The method of claim 1, wherein the message includes an Internet Protocol message.

4. The method of claim 3, wherein the Internet Protocol message includes an HTTP GET request.

5. The method of claim 1, wherein the Network Address Translation flows further instruct the Internet router to accept the incoming data on a randomized port.

6. The method of claim 5, wherein the established Network Address Translation flows allow the incoming data to securely tunnel a firewall at the Internet router.

7. The method of claim 5, wherein the incoming data from the one or more enumerated nodes bypasses restrictions that an Internet service provider has placed on traffic traversing the Internet service provider network.

8. The method of claim 1, wherein the enumerated nodes provide the requested content in an encrypted format.

9. The method of claim 8, further comprising decrypting the content at the signaling device.

10. The method of claim 1, wherein the enumerated nodes include cache nodes associated with a caching network, the enumerated nodes operable to retrieve the requested content from one or more of the destination or other nodes of the caching network.

11. The method of claim 1, wherein the message further includes a requested protocol and the enumerated nodes proxy the message by communicating with the destination using the requested protocol.

12. The method of claim 11, wherein the requested protocol includes one or more of a peer-to-peer protocol or a file transfer protocol.

13. The method of claim 11, wherein the signaling device provides the received content to the user terminal in accordance with the requested protocol.
